(19) United States
(12) Patent Application Publication
(10) Pub. No.: US 2007/0005929 A1
(43) Pub. Date: Jan. 4, 2007

(54) Method, system, and article of manufacture for sector mapping in a flash device

(76) Inventors: Daniel J. Post, Rescue, CA (US); Sunil R. Atri, Folsom, CA (US); Meenakshi Pannala, Folsom, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/173,785

(22) Filed: Jun. 30, 2005

(51) Int. Cl. G06F 12/00

(52) U.S. Cl. 711/202; 711/103; 711/105

(57) ABSTRACT

Access to a flash memory device may be virtualized by creating a mapping between logical sector numbers and physical memory location. Algorithms may be used to deprecate old sectors and to reclaim both data blocks and mapping blocks. Thus, Flash sector management may be implemented using limited amounts of RAM.

### BACKGROUND

The present invention relates to flash memory devices and more specifically to flash memory filesystems.

Currently, flash memory requires specially designed flash filesystems. This is because flash memory devices are unable to rewrite arbitrary data, and also because flash memory contains large erase blocks, which makes erasing and rewriting an entire region too time consuming to be practical.

Creation and distribution of such filesystems is not feasible in all applications. For example, a flash memory device in a card form factor may be used as a removable storage media. The flash device is ideally available to an operating system as a set of arbitrarily rewritable sectors or slots, much like a hard drive.

Random access memory (RAM) may be included in the flash device to store a locator table, thus allowing the device to be accessed in the same manner as a hard drive. However, the required amount of RAM to store the locator table may be quite large and thus cost prohibitive.

### BRIEF DESCRIPTION OF THE DRAWINGS

A better understanding of the present invention can be obtained from the following detailed description in conjunction with the following drawings, in which:

FIG. 1 is a conceptual illustration of block management within a flash device;

FIG. 2 is a conceptual illustration of a mapping table and an overflow table;

FIG. 3 is a flow diagram illustrating scan mapping according to one embodiment;

FIG. 4 is a flow diagram illustrating a read command according to one embodiment;

FIG. 5 is a flow diagram illustrating a write command according to one embodiment;

FIG. 6 is a flow diagram illustrating mapping block reclaims according to one embodiment; and

FIG. 7 is a conceptual illustration of a system block diagram according to one embodiment.

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed.

As used herein, a slot refers to a physical region within a data block. A sector refers to the logical address that indexes into a mapping table and its chains. The sector resolves to a logical block number and to a slot within that logical data block. For example, when a drive is plugged into a computer, a certain capacity for the drive is reported; the operating system may write and read sectors using a FAT filesystem. In embodiments of the present invention, sectors may be translated to slots in data blocks using mapping tables.

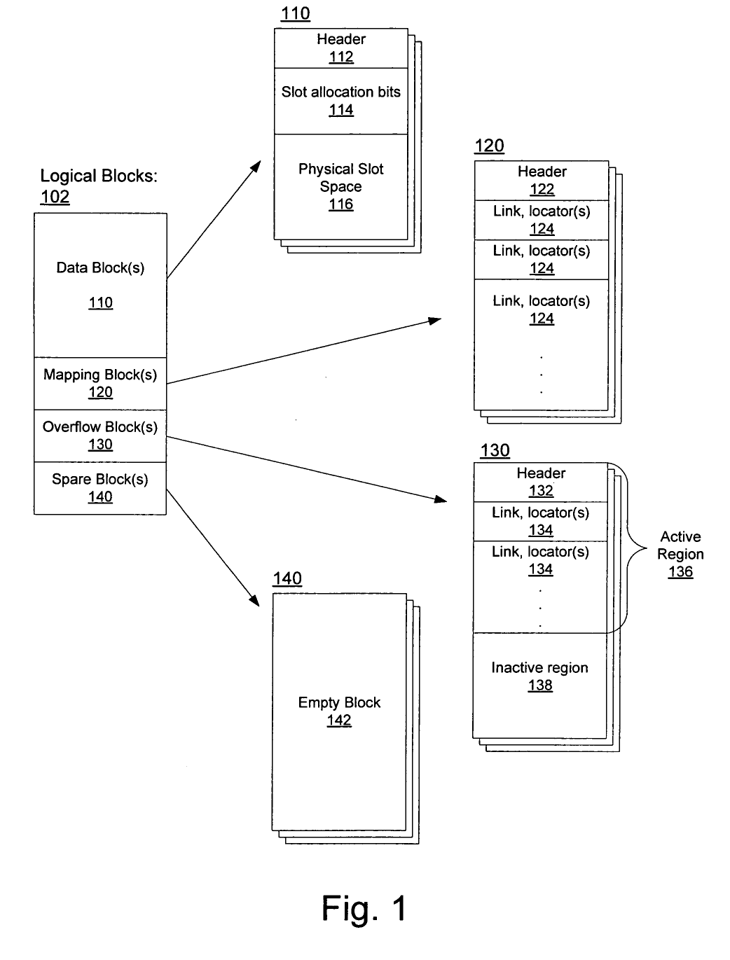

FIG. 1 illustrates the logical blocks (102) within a flash memory device according to embodiments of the present invention. The logical blocks include one or more data blocks (110), mapping blocks (120), overflow blocks (130), and spare blocks (140).

Data blocks (110) contain slots (116) which may be programmed with data, read, or erased. A slot may be any size, but is typically much smaller than a block. The slots within each data block may include allocated slots as well as non-reclaimed dirty slots. Slot status bits (114) within the data blocks indicate whether each slot within the data block is free, allocated, or dirty (deprecated). The data blocks (110) also include a header (112). The header (112) may contain information including the logical block number associated with the data block, power loss recovery (PLR) state information, or other meta-information.

Mapping blocks (120) contain a table or array (124) which locates a given slot in the data block region (110). The mapping table (124) is organized using a link chain and a locator or set of locators per record, including a terminal locator. The locators are used to determine the physical address of a slot within the flash memory array by using a logical block number and slot within the block. Using more than one locator per record increases efficiency of space usage. For example, one link with one locator is 50% efficient. One link having three locators is 75% efficient. The number of locators per link may be optimized by analyzing the number of times a slot is written before reclaim. The goal of optimization is to ensure that the majority of sectors do not require the use of overflow records (134), described below, and to increase runtime efficiency by skipping invalid locator records each time a link is followed.

Each mapping block (120) also includes a header (122), which may contain information including the logical block number associated with the mapping block, power loss recovery (PLR) state information, or other meta-information.

Overflow blocks (130) are very similar to mapping blocks, and include a header (132) and overflow table records (134). Because the mapping blocks can hold a limited number of locators before being reclaimed, and some sectors are written much more frequently than others, the overflow blocks allow an overflow through the use of the link in the mapping table and subsequent overflow records, thus reducing reclaims of mapping blocks. Thus, the link chain for frequently written sectors will overflow into an overflow block rather than forcing an immediate reclaim of a mapping block. Overflow records may have a different number of locators per link than the mapping table records. The number of locators per link in the overflow table may be tuned to make the overflow table more efficient.

There may be two overflow regions: an active region (136) and an inactive region (138), each composed of one or more blocks. When the active overflow region is full, the active region and the inactive region are swapped, allowing a reclaim of mapping blocks. When the mapping block reclaim is completed, the now-inactive overflow blocks may be erased because there will be no links in the mapping table which point to that region.

Spare blocks (140) are empty blocks which may be used as mapping blocks in the future. Each spare block may contain a signature to identify if it has been completely erased. If the signature is not present, the spare block may be erased again.

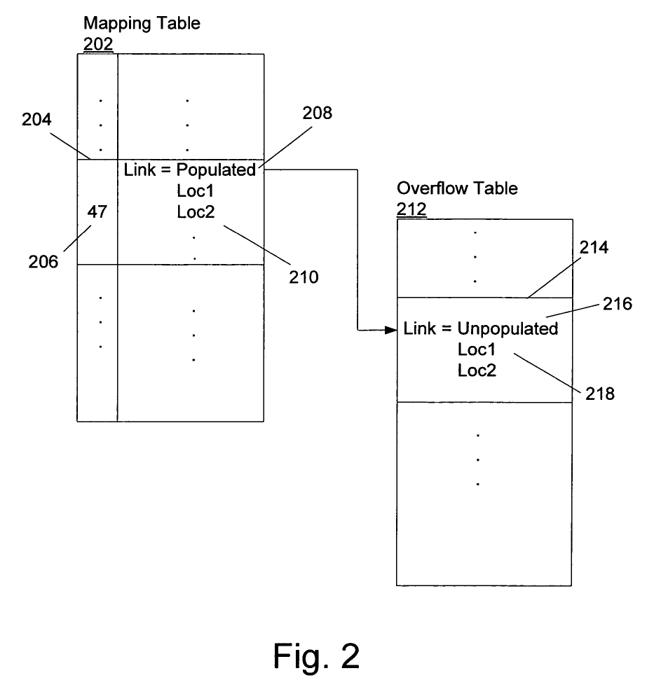

FIG. 2 is an example illustrating how the mapping table and overflow table are used to determine the terminal locator (e.g. last known physical address) for a given sector. Mapping table (202) contains a number of records (204). Each record is indexed by a record number (206), which may correspond to a sector number. Each record contains a link (208), which may be populated or unpopulated and a list of one or more corresponding locators (210). A populated link contains a pointer to another record in one of the two overflow tables, while an unpopulated link may contain a value of all zeros (hx00), which may indicate a failure and the necessity of a cleanup, or all ones (hxFF), which may indicate that the primary locator set has not yet filled.

When a logical sector number is provided, the sector number is looked up in the mapping table (202). A populated link (208) for the sector number indicates that the terminal locator for that sector is not located in the mapping table and points to the next link in the link chain. This increases efficiency, because there is no need to examine the locators under a populated link.

Here, the populated link (208) points to a record (214) in one of the overflow tables (212). The link in the overflow table is unpopulated (216). This indicates that the current record is the terminal link record, and thus, the terminal locator can be found within this record. The locator list (218) can then be scanned to determine the value of the terminal locator within the list. The terminal locator value corresponds to the physical address of the logical sector, which is the address of a slot within a data block.

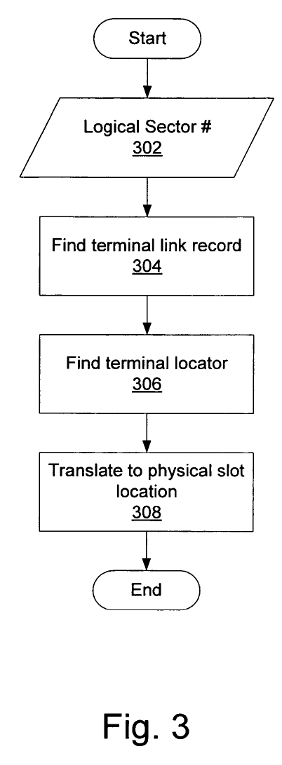

FIG. 3 is a flow diagram illustrating scan mapping of a link chain, as described above. A logical sector number or index value is provided (302). Based on the logical sector number, the terminal link record is found (304). The terminal link record is the record which contains the terminal locator, and is typically a link record whose link is unpopulated. Next, the terminal locator is found (306). The terminal locator may be determined by scanning the locator list to find the last programmed locator in the list. Once the terminal locator is found, it can be translated into a sector's physical location in memory (306).

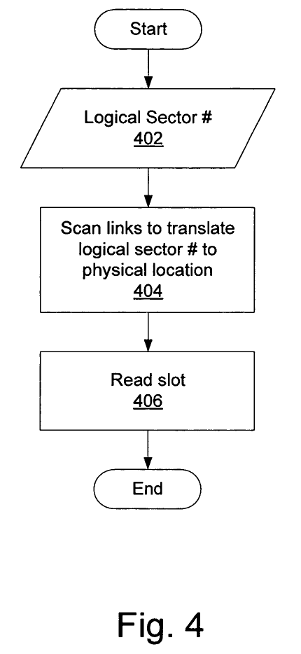

FIG. 4 is a flow diagram illustrating a read using sector based allocation according to embodiments of the present invention. A logical sector number for the sector to be read is provided (402). Next, the links in the link chain are scanned to determine the physical location of the sector in memory (404), which is the address of a slot within a logical data block. The scan process is described in detail above in conjunction with FIG. 3. Finally, after a physical address has been determined, the slot is read (406).

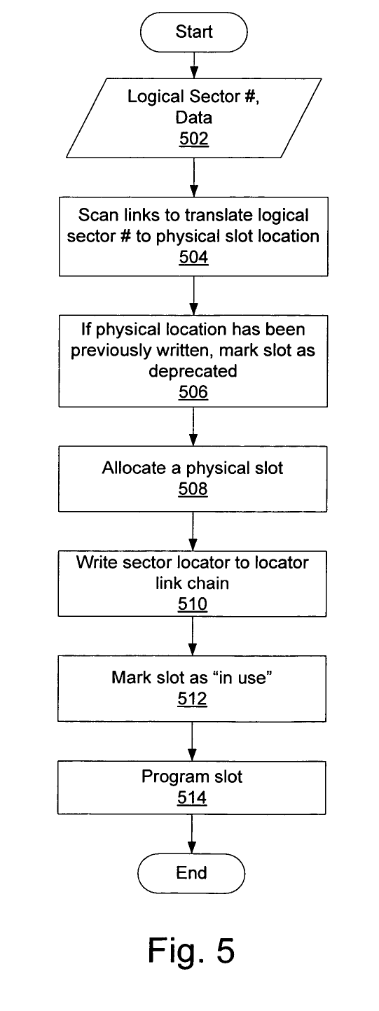

FIG. 5 is a flow diagram illustrating a write using sector based allocation according to embodiments of the present invention. A logical sector number and data to be written to that sector are provided (502). Next, the links in the link chain are scanned to determine the physical location of the sector in memory (504) (e.g. the slot within a data block). The scan process is described in detail above in conjunction with FIG. 3. If the physical location has not been previously written (505), the data may be immediately programmed in the slot (514). If the physical location has been previously written in the life of the device, the slot is marked as dirty (deprecated) (506) and a new physical slot is allocated (508). The new physical slot may be allocated by using a logical block table or by scanning the device for unallocated physical slots.

When a new physical slot is allocated, the sector locator must be written to the locator link chain. A new locator and link, if necessary, are written to the locator link chain (510). The physical slot is also marked as “in use” (512). This may be accomplished by updating the block's header. Finally, the slot is programmed (514). The slot should be marked as in use after the sector locator is written so that a power loss between those events will not cause a physical slot to avoid deprecation even if a slot with the same logical number is written to the device.

Because of the write restrictions imposed by flash memory, slots and locators cannot be reprogrammed in place. Thus, reclaims must be done for both data slots and mapping blocks.

When a given physical block in memory contains a predetermined number or percentage of dirty physical slots, a data reclaim may begin. To perform a data reclaim, a spare block is taken from the spare block pool. Each valid physical slot is copied over from the original block. When all valid physical slots have been copied, the two blocks are swapped and the old block is erased in the background.

A set of physical slots is maintained as a reserve. If the amount of unallocated physical slots falls below a certain point, a background reclaim is triggered. If tuned properly, this prevents reclaims from becoming foreground operations and will help maintain consistent throughput in the system.

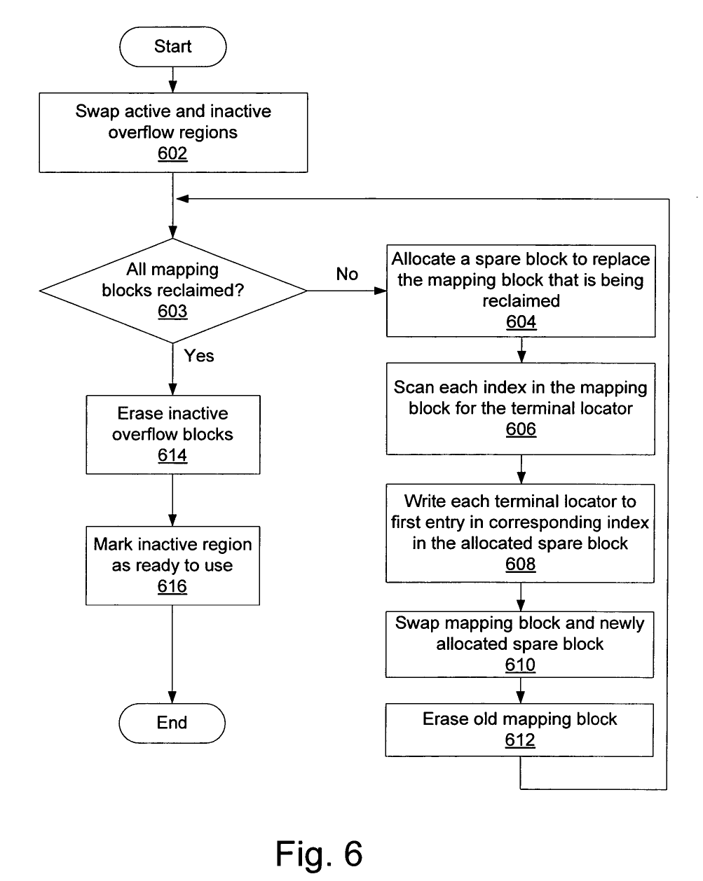

A mapping reclaim begins when the active overflow becomes full. FIG. 6 is a flowchart which illustrates the mapping reclaim process. When this occurs, the active and inactive overflow regions are swapped (602). If the inactive region is not ready to use, for example, if it is in the process of being erased, the previous reclaim must be finished before another reclaim may begin. In a properly tuned system, this should not happen.

Each block in the mapping region is reclaimed one at a time. If there are blocks remaining to be reclaimed (603), a spare block is allocated from the spare block pool to replace the mapping block that is being reclaimed (604). Each index or record within the mapping block is scanned for the terminal locator (606). The terminal locator is written as the first entry in a corresponding record in the newly allocated spare block (608). After all terminal locators have been copied to the spare block, the mapping block and spare block are swapped (610) and the old mapping block is erased in the background (612).

After all of the mapping blocks are reclaimed, the newly inactive overflow blocks may be erased one at a time (614). This may be accomplished in place or by swapping an overflow block with a block from the spare block pool. Finally, the inactive region is marked as ready for use for the next reclaim cycle (616).

If the system loses power during the reclaim cycle and is reinitialized, each block's header is examined to determine its state, and reclaims are continued. This may include erasing blocks which were previously put in the spare block pool but had not yet been completely erased.

If a data reclaim is in progress when they device is powered down, the data reclaim is detected by examining the power loss recovery (PLR) status. The data reclaim may be resumed accordingly.

An in-progress mapping reclaim is detected in a similar manner. If a mapping block was being reclaimed, the entire region reclaim may be resumed rather than just reclaim of the block.

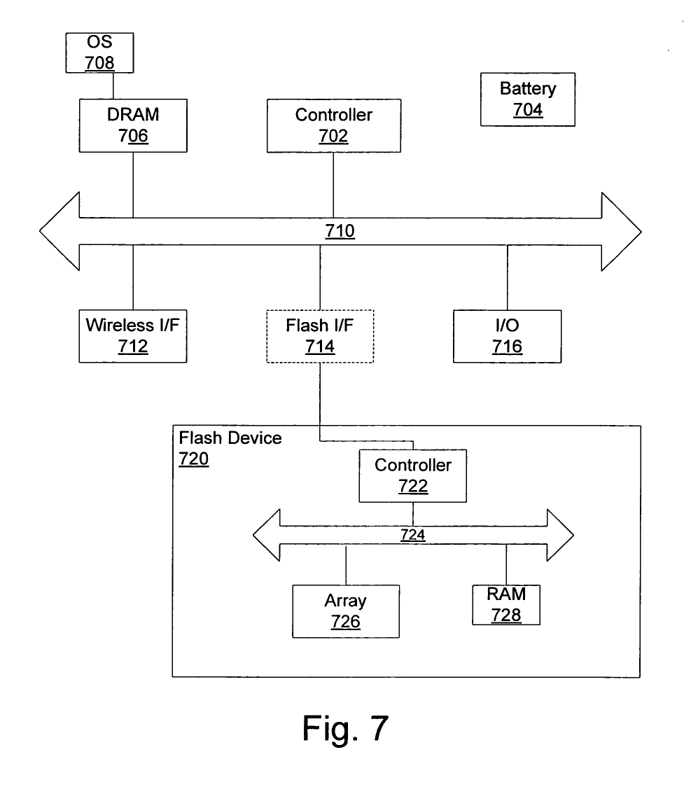

FIG. 7 is a block diagram of a system according to one embodiment of the present invention. The system may include a bus (710) which communicates with a controller (702). The controller (702) may be a microcontroller, one or more microprocessors, a digital signal processor (DSP), or another type of controller. The system may be powered by a battery (704) or may be powered with another type of power supply.

System memory or dynamic random access memory (DRAM) (706) may be coupled to the bus (710). The DRAM (706) may store an operating system (OS) (708) after system initialization.

A variety of input/output (I/O) devices (716) may be coupled to the bus (710). The I/O devices may include items such as a display, keyboard, mouse, touch screen, or other I/O devices. A wireless interface (712) may also be coupled to the bus (710). The wireless interface (712) may enable cellular or other wireless communication between the system and other devices. In one embodiment, the wireless interface (712) may include a dipole antenna.

The system also includes a flash memory device (720). The flash memory device may be built into the system, or may be part of a removable storage medium, such as a card form factor, that may be inserted into an optional flash card interface (714).

The flash memory device (720) includes a controller (722) coupled by a bus (724) to the flash array (726) and a small random access memory (RAM) (728) (e.g. several hundred bytes to a few kilobytes). Logical blocks, including data blocks, mapping blocks, overflow blocks, and spare blocks, are stored within the flash array (726) and are managed by software stored within the RAM (728).

The RAM (728) may also be used to store a small table to track physical offsets as well as information about the number of deprecated slots per block and the location of the next free slot per block.

The methods set forth above may be implemented via instructions stored on a machine-accessible medium which are executed by a processor. The instructions may be implemented in many different ways, utilizing any programming code stored on any machine-accessible medium. A machine-accessible medium includes any mechanism that provides (i.e., stores and/or transmits) information in a form readable by a machine, such as a computer. For example, a machine-accessible medium includes random-access memory (RAM), such as static RAM (SRAM) or dynamic RAM (DRAM); ROM; magnetic or optical storage medium; flash memory devices; electrical, optical, acoustical or other form of propagated signals (e.g., carrier waves, infrared signals, digital signals); etc.

Thus, sector based allocation for a flash device is disclosed. In the above description, numerous specific details are set forth. However, it is understood that embodiments may be practiced without these specific details. In other instances, well-known circuits, structures, and techniques have not been shown in detail in order not to obscure the understanding of this description. Furthermore, although some embodiments have been described as a series of operations which occur in a particular order, it may be possible to perform these operations in a different order as well. Embodiments have been described with reference to specific exemplary embodiments thereof. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

We claim:

1. A method comprising:
mapping logical sector numbers to physical memory locations in a mapping region having one or more mapping blocks and at least one map overflow, wherein the map overflow contains an active overflow region and an inactive overflow region;
swapping the active overflow region and the inactive overflow region; and
reclaiming each mapping block.

2. The method of claim 1, wherein each mapping block includes a header and one or more link records, each link record containing one or more locators, including a terminal locator.

3. The method of claim 2, wherein reclaiming each mapping block comprises scanning each link record within the mapping block for the terminal locator, writing each terminal locator as the first entry of a corresponding link record in a newly allocated spare block, swapping the mapping block and the newly allocated spare block, and erasing the mapping block.

4. The method of claim 3, further comprising erasing the inactive overflow region.

5. The method of claim 1, wherein swapping the active overflow region and the inactive overflow region occurs when the active overflow region is full.

6. A system comprising:
a bus;
a processor coupled to the bus;
a wireless interface coupled to the bus; and
a flash memory device coupled to the bus, the flash memory device containing memory adapted for storing instructions, which upon execution by a controller within the flash memory device, cause a locator to be written to a record within an overflow block, an active overflow region and an inactive overflow region to be swapped, one or more mapping blocks to be reclaimed, and the inactive overflow region to be erased.

7. The system of claim 6, wherein the locator contains the physical address of a slot.

8. The system of claim 6, wherein the active region and the inactive region are swapped when the active region is full.

9. The system of claim 6, wherein each mapping block includes a header and one or more link records, each link record containing one or more locators, including a terminal locator.

10. An article of manufacture comprising a machine-accessible medium having stored thereon instructions which, when executed by a machine, cause the machine to:
scan links in a link chain to determine the physical location of a data slot within a data block;
mark the slot as dirty if it has been previously written;
allocate a new physical slot;
write a new locator to the link chain;
mark the physical slot as in use; and
program the slot.

11. The article of manufacture of claim 10, wherein the link chain resides in one or more mapping blocks and one or more overflow blocks.

12. The article of manufacture of claim 10, further comprising instructions which, when executed by the machine, further cause the machine to reclaim data blocks.

13. The article of manufacture of claim 12, further comprising instructions which, when executed by the machine, further cause the machine to reclaim mapping blocks.
